(19) United States
(12) Patent Application Publication
(10) Pub. No.: US 2006/0101129 A1
(43) Pub. Date: May 11, 2006

(54) Positive identification device, particularly for hospital health technology

(76) Inventors: Michele Rubertelli, Trento (IT); Marco Rossi, Trento (IT)

Correspondence Address: Modiano & Associati, Via Meravigil 16, 20123 Milano, Italy, IT

(21) Appl. No.: 10/533,455

(22) PCT Filed: Oct. 24, 2003
(86) PCT No.: PCT/EP03/11823

§ 371 Date: Oct. 21, 2005

(30) Foreign Application Priority Data
Nov. 5, 2002 (IT) VR2002A000112

(51) Int. Cl. G06F 15/16

(52) U.S. Cl. 709/217

(57) ABSTRACT

A positive identification device particularly for establishing correctly a correlation between a hospital product or patient to be correlated and at least one hospital product or patient that is correlated to the hospital product or patient to be correlated, comprising a first memory, which can be affixed to the hospital product or patient to be correlated and store a predefined unique identification code for the hospital product or patient to be correlated, and a second memory, which can be affixed respectively to the correlated hospital product or patient, the device further comprising elements for remote transfer of data, adapted to download by remote transmission the content of the first memory into the second memory.

The present invention relates to a positive identification device, particularly for correctly establishing the correlation between a hospital product or patient to be correlated and at least one correlated hospital product or patient, the device being particularly but not exclusively useful in the field of hospital health technology and in particular in the field of blood transfusions, preparations of antiblastic drugs, and mixtures for parenteral nutrition, histological specimen testing, laboratory testing in general and obstetrics, as well as in the management of operating rooms.

### BACKGROUND OF THE INVENTION

In hospital activity there is the everyday need to correctly assign to a patient blood or blood fractions or other products, such as for example drugs, that are specifically compatible with that patient.

The process for collecting, preparing, assigning and infusing blood or its components is very complicated, and therefore the possibility of potentially fatal severe human error is considerable (some estimates report one incorrect transfusion every 1800 transfusions).

Human error is the most frequent cause of fatal hemolytic transfusion reactions and can occur in the following cases: when blood is collected from the patient in order to determine the patient's blood group, when previously prepared blood is distributed, or when blood is infused to the patient.

Errors can also occur in typing donated blood or in labeling blood bags.

Similar problems due to mistaken identities or blood samples mix-ups can occur in other hospital activities, such as the administration of drugs, laboratory tests, delivery rooms (mixed-up newborns), and so forth.

In order to try to solve this problem, various procedures have already been introduced which are used exclusively in the transfusion field and can be performed by means of devices based on various constructive criteria.

Among these, mention can be made of a device that provides for the adoption of a bracelet that is worn by the patient and bears a three-letter alphanumeric code.

Nursing staff copies this identification code of the bracelet onto the test tubes for compatibility tests and on blood requests, but it is forbidden to copy the code onto the patient's medical record.

Compatible blood units prepared by the transfusion center are individually placed in a pouch that is closed with a plastic lock formed by three concentric wheels of different diameters, each of which bears, on its outer edge, the letters of the alphabet.

Upon closure, the three wheels are moved out of alignment.

When the pouch is to be infused, the health worker reads the code on the bracelet of the patient and realigns the three wheels so as to reproduce the sequence of the code; at this point the lock opens and the bag becomes usable.

Although this system is very simple, it does not ensure complete safety, especially if one considers the fact that the three-letter code does not provide assurance of being unique, since the number of possible combinations that can be obtained does not provide absolute assurance that in the hospital there are no two patients identified by means of the same code.

Furthermore, the system can be rendered ineffective easily as a consequence of inappropriate use.

It is sufficient to consider the fact that nursing staff very often tends to copy the code not from the bracelet but from the medical record, accordingly introducing possible errors.

Another known system to allow correct identification of patients uses a handheld computer connected to a portable printer, which allows to produce in the ward a label that bears a bar code that encodes the name and surname of the patient, his date of birth and his hospital identification code.

This label is applied to a bracelet that is worn by the patient.

At the time of collection for determining the blood group and/or for pretransfusion compatibility tests, the nurse, by using an appropriately provided device included in the handheld computer, reads the bar code on the bracelet of the patient and produces labels that bear the same bar code in order to identify the test tubes to be sent to the laboratory and the corresponding request forms.

The same identifying bar code is then used by the transfusion center to enter the blood requests in the computerized system of the center and to print the compatibility labels to be applied to the bags that contain the blood units to be transfused.

When transfusion is performed, the physician and the nurse, in the vicinity of the patient's bed, use the handheld computer to enter their identification code and read the bar code of the bracelet, the bar code of the unit to be transfused and the bar code of the compatibility label.

If the codes match, transfusion begins, otherwise an acoustic alarm is activated.

At the end of the transfusion, the nurse records his or her identification code, the identification code of the patient and the identification code of the compatibility label and prints a final report that includes the type of component, the transfusion time and any adverse events.

A copy of this report is kept in the patient's medical record, while another copy is sent to the transfusion center.

Differently from the system described above, this system offers the advantage of being electronic and at the same time allows to document the transfusion.

However, it has the disadvantage of not having a physical barrier and of being rather complicated; the bar code in fact must first be applied to the patient's bracelet and this makes the system scarcely practical in emergency situations.

Another problem further arises from the fact that sometimes there are difficulties in reading the bar code, both because the label on which it is printed is subject to deterioration, and because in the case of surgery the label is not easy to reach due to the position assumed by the wrist of the patient.

Another system is also known in which identification of the patient is ensured by an electronic chip, known as I-Button, which is inserted in a bracelet of the pediatric type.

A globally unique code, known as PID, is pre-entered in the electronic chip.

Various other items of information, such as for example the identification data of the patient, his hospital identification code, his blood group, and so forth, can be added to the memory of the electronic chip, even at a later time, by using a handheld computer that can be connected circuitally to said chip by means of cables.

When blood is collected for blood group typing and/or pre-transfusion compatibility tests, safety labels are produced by connecting the electronic chip on the bracelet to a printer and to the handheld computer.

These labels are designed to assuredly identify the blood samples intended for the testing laboratory of the transfusion center in order to determine the blood group or for hemocompatibility tests and also to correctly specify the name of the individual in the request forms.

On the request forms, the PID of the patient is provided as a bar code, which is printed by means of the handheld computer and the printer connected thereto.

The blood bags compatible with the patient in turn have an identification code.

The identification code of the bags is then associated with the PID of the patient by entering it, together with said PID, in a preassignment file.

During assignment/delivery, the bag that contains the compatible blood is placed in a pouch, which is then sealed by means of an electromechanical closure device.

Such closure device is provided with a memory cell in which the PID of the patient and the bag identification code are loaded, and is structured so as to close only if the code of the bag placed in the envelope matches one of the codes that are present in the preassignment file.

Upon transfusion, the device for closing the pouch is circuitally connected to the chip that is present on the bracelet of the patient and to the handheld computer.

If the handheld computer recognizes the match between the PID of the patient and the PID stored in the memory cell of the closure device, said closure device opens, releasing the bag and allowing its transfusion.

All the information related to the performed transfusion (for example its start and end times or any transfusion reactions) are recorded on the handheld computer and are provided on a label, known as transfusion report, to be attached to the medical record.

The memory cell of the closure device likewise also stores all the events related to the process followed by the bag, such as the date and time of locking and unlocking, incorrect unlocking attempts, and so forth.

Finally, the closure device is returned to the transfusion center and its content is downloaded onto a PC, so that the service has at its disposal a transfusion report or event log related to each transfused unit.

The system described above, despite having the advantage of mechanical-electronic locking of the pouches for containing the bags to be transfused, provided by means of said closure device, is not free from drawbacks.

First of all, it is composed of components that are particularly bulky and for this reason it is scarcely appreciated by operators; the handheld computer, for example, is rather heavy and the printer is separate from the handheld computer.

Secondly, the system is rendered complicated by the series of cables that connect the handheld computer, the printer, the closure device and the electronic chip on the bracelet of the patient.

Furthermore, the system is often irregular in its operation, since it tends to jam due to errors of the handheld computer.

For these reasons, it is scarcely used in those hospitals where it has been adopted.

### SUMMARY OF THE INVENTION

The aim of the present invention is to eliminate the drawbacks noted above in known types by providing a positive identification device, particularly for correctly establishing the correlation between a hospital product or patient to be correlated and at least one first correlated hospital product or patient, which allows to ensure a high degree of safety in the allocation of blood or other products to the correct patient, in practice eliminating the possibility of involuntary identification errors throughout the process for sample collection and analysis, assignment, delivery and administration to the patient of the requested product.

Within this aim, an object of the present invention is to provide a positive identification device that can offer better reliability in operation.

Another object of the present invention is to provide a positive identification device that can be effectively used to collect and transfuse blood, to administer antiblastic drugs, for histological tests and laboratory tests and for preventing newborn mix-ups.

Another object of the present invention is to provide a positive identification device that has a very simple structure and is compact.

Another important object is to provide a positive identification device that is highly durable, easy to use and competitive in terms of manufacturing costs.

Another object of the invention is to provide a positive identification device that is capable of solving the problem, strongly felt in operating rooms, of checking whether the instruments used during surgery have not been accidentally left inside the patient after the operation.

This aim, as well as these and other objects that will become better apparent hereinafter, are achieved by a positive identification device particularly for correctly establishing a correlation between a hospital product or patient to be correlated and at least one hospital product or patient that is correlated to the hospital product or patient to be correlated, according to the invention, characterized in that it comprises:

first memory means, which can be affixed to said hospital product or patient to be correlated and store a predefined unique identification code for said hospital product or patient to be correlated;

second memory means, which can be affixed to said at least one hospital product or patient that is correlated to said first hospital product or patient to be correlated;

means for remote transfer of data, adapted to download by remote transmission the content of said first memory means into said second memory means.

Advantageously, the device according to the invention comprises comparator means that are adapted to compare the content of said first memory means with the content of said second memory means in order to verify their correlation.

Conveniently, the device according to the invention is provided with a transponder for identifying the hospital product or patient to be correlated, which comprises said first memory means and can be associated with said first hospital product or patient to be correlated, and at least one correlation transponder, which comprises said second memory means and is respectively associable with said at least one correlated hospital product or patient, said remote data transfer means comprising means radio-frequency transponder reading means and radio-frequency transponder programming means.

According to another aspect of the invention, a method is provided for correctly establishing a match between a hospital product or patient to be correlated and at least one hospital product or patient that is correlated to said first hospital product or patient to be correlated, by means of a device according to the invention, characterized in that it comprises the steps of:

assigning to said hospital product or patient to be correlated first memory means that store a predefined unique code for identification of said first hospital product or patient to be correlated,

remotely transmitting and loading the content of said first memory means into second memory means associated respectively with said at least one correlated hospital product or patient,

performing a procedure for comparing the content of said first memory means and the content of said second memory means.

### BRIEF DESCRIPTION OF THE DRAWINGS

Further characteristics and advantages of the invention will become better apparent from the description of a preferred but not exclusive embodiment of a device for positive identification of a patient-recipient, particularly for correctly assigning a hospital product, according to the invention, illustrated by way of non-limitative example in the accompanying drawings, wherein:

FIG. 1 is a perspective view of an identification bracelet provided with an identification transponder;

FIG. 2 is a view of a blood bag provided with a correlation transponder;

FIG. 3 is a view of a test tube to which a correlation transponder is applied;

FIG. 4 is a view of a scalpel provided with an identification transponder;

FIG. 5 is a perspective view of a container for the scalpel of FIG. 4, said container being provided with a correlation transponder;

FIG. 6 is a schematic perspective view of a card provided with an identification transponder;

FIG. 7 is a schematic view of a request form provided with a correlation transponder;

FIG. 8 is a front elevation view of a processor-equipped device;

FIG. 9 is a perspective view of the printing means;

FIG. 10 is a side view of a computer of the portable type connected to USB and IrDA interfaces:

FIG. 11 is an enlarged-scale view of a detail of the bottom portion of a test tube, similar to the one of FIG. 3, in which a correlation transponder is inserted;

FIG. 12 is a side view of a processor-equipped device provided with a seat that engages the bottom portion of a test tube similar to the one of FIG. 3;

FIG. 13 is a view of networked computers;

FIG. 14 is a general block diagram of the processor-equipped device of FIG. 8;

FIG. 15 is a view of a correlation bracelet provided with a correlation transponder.

In the examples of embodiment that follow, individual characteristics, given in relation to specific examples, may actually be interchanged with other different characteristics that exist in other examples of embodiment.

### DESCRIPTION OF THE PREFERRED EMBODIMENTS

With reference to the figures, a positive identification device, particularly for correctly establishing the correlation between a hospital product or a patient to be correlated and at least one hospital product or patient that is correlated to the hospital product or patient to be correlated, according to the invention, generally comprises first memory means that are designed to be assigned to the hospital product or patient to be correlated.

The positive identification device according to the invention further uses second memory means, which are designed respectively to be assigned and affixed to one or more hospital products or patients that are correlated to the hospital product or patient to be correlated.

Also according to the invention, remote data transfer means are provided which in practice are designed to transmit remotely and write in the second memory means the data recorded in the first memory means, so as to create an information link between the hospital product or patient to be correlated and the hospital products or patients that are correlated thereto.

By way of the remote data transfer means, the positive identification device according to the invention is therefore capable of assigning to the correlated hospital products or patients the same information that is associated with the hospital product or patient to be correlated and is stored in the first memory means, by loading the information also in the second memory means.

Conveniently, the remote data transfer means are also suitable to remotely transmit the content of the second memory means to the first memory means; this allows to download into the first memory means the data recorded in the second memory means.

Advantageously, the positive identification device according to the invention is further provided with comparator means, which are adapted to compare the content of the first memory means with the content of the second memory means in order to check their match.

This allows to perform cross-identification operations that ascertain the existence of a correlation between the hospital product or patient to be correlated and the correlated hospital products or patients.

Broadly speaking, a hospital product to be correlated is any product used in the hospital sector, such as an instrument, an apparatus, a document, a drug, that requires, as part of a process performed within a health facility, to be associated with, or related to, another hospital product or a patient who is a resident of the health facility.

Any hospital product, included for example among the ones mentioned above, which must be allocated or at least traceable to a specific hospitalized patient or to another hospital product is instead to be considered as a correlated hospital product.

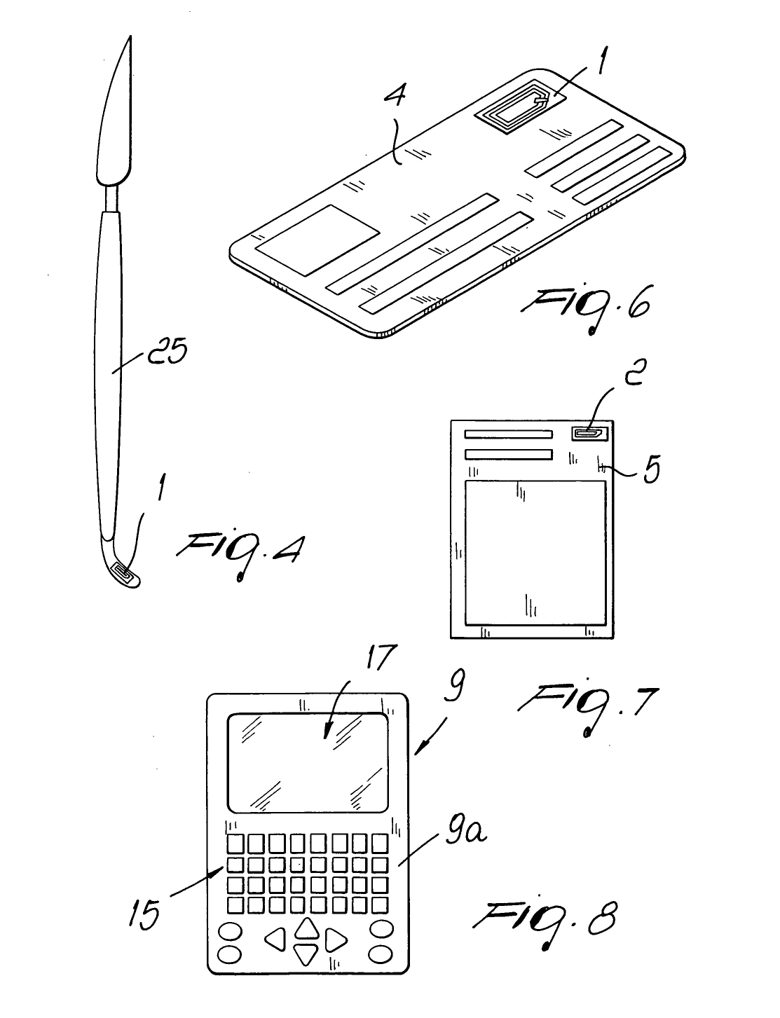

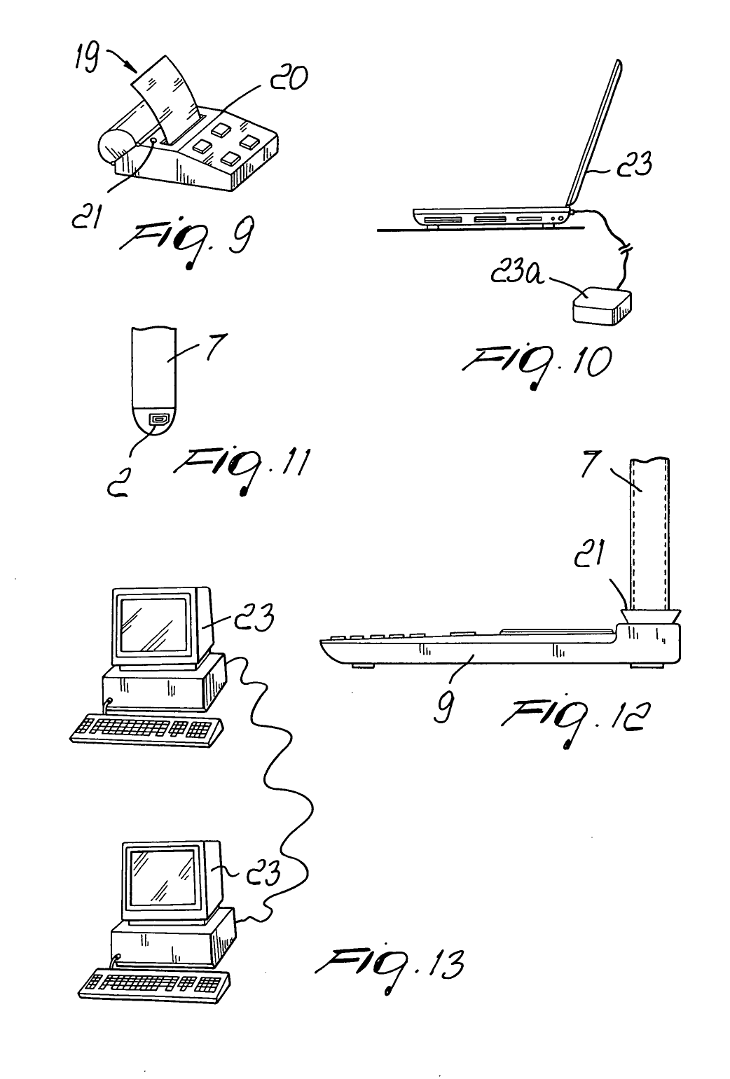

In detail, a hospital product can be for example a test tube, such as the one designated by the reference numeral 7 in FIG. 3, which contains a liquid to be analyzed in a laboratory, such as blood collected from a patient, a bag 6 (shown in FIG. 2) that contains for example blood to be infused to a patient-recipient, an antiblastic preparation or a drug to be administered, a request form (designated by the reference numeral 5 in FIG. 7), for example to request preparations and/or drugs or laboratory tests, a report that contains the results of laboratory tests, for example, on the blood group of a patient, a surgical instrument such as forceps, a scalpel 25 (shown in FIG. 5), a pair of scissors, a Klemmer forceps, a dressing, such as a bandage or gauze, a box 8 (for example of the type shown in FIG. 4) that is adapted to accommodate a corresponding surgical instrument, any container intended to store any of the above cited hospital products.

The expression “patient to be correlated” designates any guest of a health facility who must be associable with one or more hospital products or other patients, such as for example a patient who is candidate for a transfusion or for the administration of a specific drug, or blood donor or a mother hospitalized in an obstetrics ward; a correlated patient, instead, can be for example a newborn, who must be matchable with full safety with the corresponding mother.

The first memory means have the particularity of storing a predefined unique code for identifying the hospital product or patient to be correlated with which they are associated; such code is not modifiable and is preferably pre-entered during their manufacture.

In particular, the first memory means can be supported by an identification bracelet 3a or a card 4, to be given to a patient to be correlated, or can be affixed, by way of suitable coupling means, to a hospital product to be correlated.

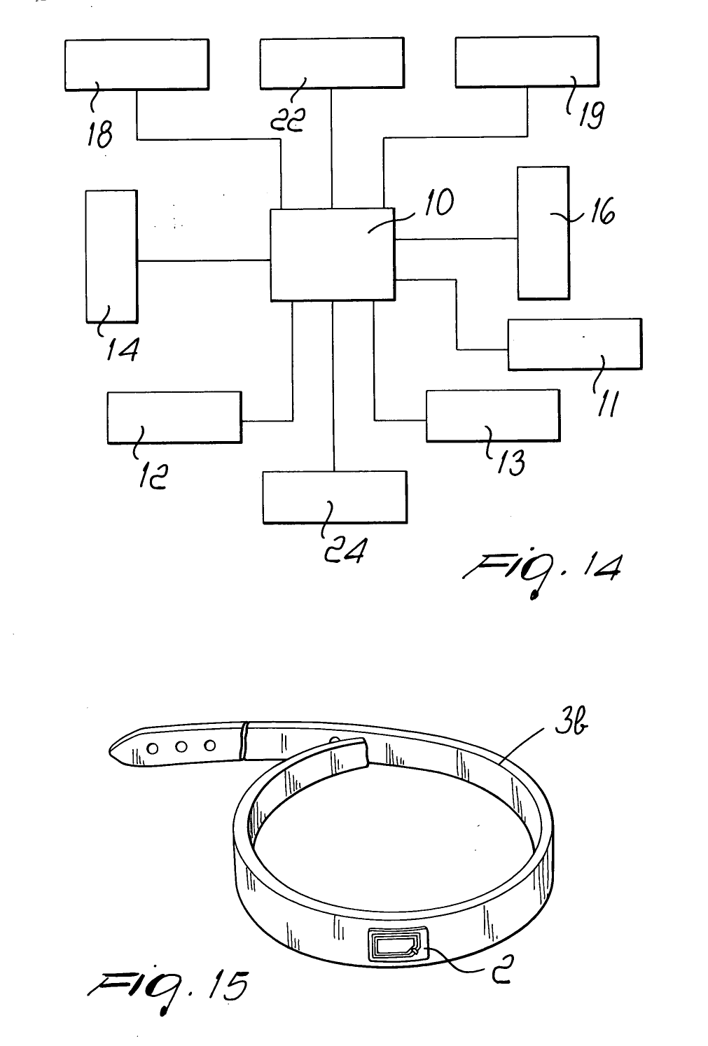

Likewise, the second memory means can be supported by a correlation bracelet 3b, which is constituted for example by a strap (as shown in FIG. 15) that can be worn by a correlated patient, or can be affixed directly to a correlated hospital product.

The important particularity of the remote transfer means resides in that they do not entail any physical or direct contact between said means and the first and second memory means respectively, or directly between the first and second memory means.

In particular, the remote transfer means operate by radiofrequency.

In practice, they can transfer information by means of radio waves, for example in the range substantially comprised between 125 kHz and 134 kHz (‘low’ frequency) or at frequencies substantially around 13.56 MHz (‘high’ frequency) or also in the frequency range substantially comprised between 868 and 2450 MHz (high frequency UHF/microwaves).

Advantageously, the first memory means store not only the predefined unique identification code of the hospital product or patient to be correlated but are also adapted to store additional data related to the hospital product or patient to be correlated.

Such means can also store data related to the correlated hospital product or products or patient or patients.

A particular aspect of the positive identification device according to the invention resides in that it uses specific transceiver devices, known as transponders, which are per se known and commercially available and are constituted by passive electronic circuits provided with at least one memory unit.

An important advantage of this constructive choice is constituted by the fact that the transceiver devices, described in greater detail hereinafter, are marked and rendered uniquely identifiable by manufacturers by means of a preset non-modifiable unique code that is stored in their memory unit.

In greater detail, an identification transponder 1 for the hospital product or patient to be correlated, designed to be assigned to the hospital product or patient to be correlated, and at least one correlation transponder 2, designed to be assigned to a respective correlated hospital product or patient, are used.

More particularly, the first memory means and the second memory means cited above are constituted respectively by the memory unit of said identification transponder 1 and of said correlation transponder or transponders 2.

Even more particularly, and as mentioned above, a preset non-modifiable unique code is conveniently pre-entered by the manufacturer of the transponder and constitutes the predefined unique identification code for the hospital product or patient to be correlated.

Advantageously, as mentioned above regarding the first memory means, it is possible to load into the memory unit of the identification transponder 1 additional data related to the hospital product or patient to be correlated.

If the identification transponder 1 is assigned to a patient to be correlated, such additional data consist of specific information for more precise identification of the patient to be correlated, such as for example his personal details or other data, such as his clinical condition, the result of certain laboratory tests, the type of request or sample collected, the date, name or code of the sample collector, and so forth.

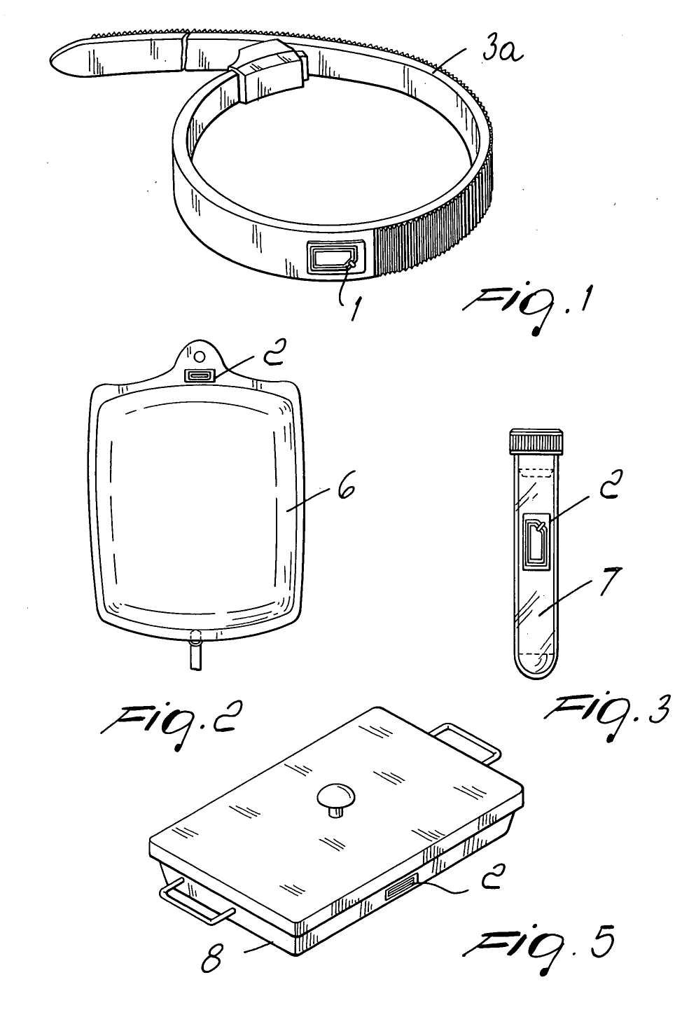

Conveniently, as shown in FIGS. 1 and 6, the identification transponder 1 can be affixed to an identification bracelet 3a, for example of the pediatric disposable type, or to a card 4 if it is designed to be assigned to a patient to be correlated, or can be affixed directly in any suitable manner to a hospital product to be correlated.

Equivalently, the correlation transponder or transponders 2 can be monolithically associated with a correlation bracelet 3b, to be assigned to a respective correlated patient, or can be coupled directly to a respective correlated hospital product.

Advantageously, it is possible to provide affixing means for the identification transponder 1 and for the correlation transponders 2, which are constituted for example by adhesive labels or Smart Labels, which allow convenient and safe anchoring of the identification transponder 1 and of the correlation transponders 2 to a hospital product to be correlated and to the correlated hospital products, respectively.

In particular, the adhesive labels allow to apply with absolute simplicity the identification transponder 1 and more particularly, as shown by FIGS. 2, 3 and 4, the correlation transponders 2 to documents, such as request forms 5, or to containers, such as the bags 6, for example for blood or drugs, the test tubes 7, the boxes 8 for surgical instruments.

Preferably, the identification transponder 1 and the correlation transponders 2 are constituted by circuits that are compatible with ISO 15693, ISO 14443 and/or ISO 18000, in which a predefined unique identification code has been introduced at the factory or by the distributor.

More preferably, they can be constituted by proprietary chips manufactured by I-Code, TagIt, Gemwave Folio, and so forth.

It is also possible to provide containers that already include the identification transponder 1 or the correlation transponders 2, as in the case of test tubes 7 made of glass or other material, in the bottom of which it is possible to insert one of said chips, during manufacture, as shown in FIG. 11.

Finally, it should be noted that it is preferable for the identification transponder 1 and the correlation transponders 2 to be disposable, i.e., easy to dispose of, for example together with the identification containers or bracelets 3a, or correlation containers or bracelets 3b, to which they are affixed, after performing the procedure for assigning correlated hospital products or patients to the hospital product or patient to be correlated.

Conveniently, the remote data transfer means use at least one processor-equipped device 9, which comprises, in a box-like containment structure 9a, processor-equipped control means 10, which are meant in general to supervise its operation, and at least one memory 11.

Advantageously, the processor-equipped device 9 is further provided with radiofrequency transponder reading means 12 and with radiofrequency transponder programming means 13, functionally connected to the processor-equipped control means 10.

The radiofrequency transponder reading means 12 and the radiofrequency transponder programming means 13 allow the processor-equipped device 9 respectively to access the data stored in the memory unit of the identification transponder 1 and in the memory unit of the correlation transponder 2 (in other words, in the first and second memory means) and to load into the memory units the data meant to be stored therein, during the various steps of the hospital processes in which the use of the positive identification device according to the invention is suggested.

Advantageously, the processor-equipped device 9 also has data input means 14, constituted for example by a keypad 15, by means whereof the hospital staff can enter the data that must be transmitted to the identification transponder 1 or to the correlation transponders 2 and must be stored in the first and/or second memory means.

Conveniently, the processor-equipped control means 10 are further functionally connected to display means 16, constituted for example by a monitor 17 of any suitable type and are suitable to display the content of the first memory means and of the second memory means read by the radiofrequency transponder reading means 11.

According to an important aspect of the invention, the comparator means are associated with the processor-equipped device 9.

In this regard, the processor-equipped device 9 can be programmed so that the processor-equipped control means 10 are capable of performing a comparison between the content of the first memory means and the content of the second memory means and more precisely between the data stored in the second memory means and the predefined unique identification code stored in the first memory means.

Advantageously, the processor-equipped device 9 is further provided with signaling means 18 that are adapted to signal the match, verified as described above by the control and processing means 10, between the data contained in the second memory means and the predefined unique identification code, in order to allow positive ascertainment of the correlation between the hospital product or patient to be correlated and the respective correlated hospital products or patients, during operations for assigning/allocating the latter to the hospital product or patient to be correlated.

In particular, the signaling means 18 can use acoustic and/or luminous signaling devices, not shown.

The processor-equipped device 9 can be conveniently connected to printing means 19, which are constituted for example by a printer 20, preferably of the thermal type on rollers, preferably adhesive rollers, so as to allow to produce adhesive labels that bear the data stored in the first and/or second memory means to be applied for example to containers such as the bags 6 or the test tubes 7 or to the request forms 5.

The printing means 19 or optionally the processor-equipped device 9 can be conveniently provided with a seat 21, which accommodates radiofrequency transponder reading means 11 and in which it is possible to insert a test tube, for example of the type designated by the reference numeral 7 in FIG. 3, which is provided with a correlation transponder 2, so that as a consequence of the insertion of the test tube 7 the printing means 18 automatically produce a preset number of adhesive labels bearing the data stored in the correlation transponder 2.

It is fully obvious that if an identification transponder 1 is applied to the test tube 7 instead of a correlation transponder 2, the data printed by the printing means 19 upon insertion of the test tube 7 in the seat 21 are the data stored in the memory of the identification transponder 1.

Advantageously, the processor-equipped device or devices 9 can be provided with means 22 for interfacing with at least one computer 23, such as a conventional personal computer, even a portable one, as shown in FIG. 10, in order to allow them to communicate and exchange information, for example, with the computers 23, which are commonly connected in a network, such as the ones of FIG. 13, with which for example a ward of the hospital, a transfusion center or a testing laboratory can be for example equipped.

Merely by way of example, the interfacing means 22 can operate by infrared rays or by means of a USB interface, so that the computers 23 are provided with, or associated with, USB and IrDA interfaces 23a, as shown in FIG. 10.

Furthermore, the computers 23 can be equipped with software for managing the processor-equipped device or devices 9 and with software for managing the data downloaded from them, which in this manner can be used for internal statistics and reports.

If connected in a local network and if connected to a database of hospitalized patients used within the hospital, computers 23 can be used for preventive transfer, onto the processor-equipped device or devices 9, of the information related to the patients to be correlated or to the correlated patients, said information being thus simply retrieved from said database instead of being entered manually when the various processes begin.

Preferably, the processor-equipped devices 9 are provided with an independent power supply and have a limited weight, so that they can be transported easily.

For example, processor-equipped devices 9, constituted by conventional computers of the handheld type (PDT) and preferably by handheld computers operating on the PalmOS, PocketPC or Windows CE platforms, provided with RF interface, which supports the radiofrequency transponder reading means 12 and the radiofrequency transponder programming means 13, and provided with a memory 11 of the Flash type with a capacity of at least 2 Mb, have been found to be particularly suitable for the contingent application for storing all the data transactions performed with the identification transponder 1 or with the correlation transponder 2 and/or with the computers 23.

Conveniently, the processor-equipped devices 9 are equipped with software developed in order to allow management of the various steps of the processes, in which it is necessary to read, write and compare the data contained in the first and/or second memory means.

The processor-equipped devices 9 may furthermore be equipped with encryption/decryption means 24, which are adapted to encrypt and decrypt one or more data items that are present in the first and/or second memory means, so that said second memory means, in compliance with privacy laws and laws covering sensitive data, do not contain data in plaintext, i.e., unencrypted and therefore directly readable. Data encryption ensures, moreover, the reliability and consistency of the data item stored in the transponder, since it certifies its origin and verifies that it has not been altered accidentally during the various processes.

Some possible applications of the device according to the invention are described hereinafter, particularly its application in processes for collecting donated blood, processes for transfusing blood, processes for administering antiblastic drugs, histological tests and laboratory tests and neonate identification.

In the case of processes for collecting donated blood, a patient to be correlated, who in this case is a blood donor, is provided with a card 4, which bears an identification transponder 1 provided with the first memory means, which contain: the predefined unique identification code of the first patient, which in this case is constituted by a preset sequential code for identifying the donor, the identification data of the first patient, and his blood group.

After admission, during collection, the nursing staff, by means of a processor-equipped device 9, loads the information contained in the identification transponder 1 into a correlation transponder 2 located on a correlated hospital product constituted by a bag 6, which is filled with the blood donated by the patient to be correlated.

The bag 6 that contains the donated blood is thus linked to the donor with absolute safety, without the need to provide other identifying indications in plaintext.

Then, the blood contained in the bag 6 is subjected to normal operations for fraction separation, and the resulting blood fractions are then placed in respective bag-like containers, not shown.

At least the bag-like container intended to receive the red cells is provided with a second correlation transponder 2, in which, again by means of a processor-equipped device 9, the information stored on the correlation transponder 2 applied to the donated blood bag 6 are loaded.

Once the laboratory tests prescribed by the law have been performed as standard, the results of the laboratory tests (group, Rh, serological tests) are transferred into the correlation transponder 2 placed on the donated blood bag 6, by way of the data input means 14 and the radiofrequency transponder programming means 13 of a processor-equipped device 9.

The physician, after signing for approval the laboratory tests, is able to read their results, loaded in the correlation transponder 2 on the donated blood bag 6 by means of the radiofrequency transponder reading means 11 of a processor-equipped device 9.

By virtue of the printing means 19 it is possible to produce a label that accurately reproduces the information regarding the donor and the laboratory data without the risk of swapping or mistakes in transcription.

It is then possible to enter in the memory unit of the correlation transponder 2 placed on the donated blood bag 6 the data related to the recipient patient to whom the bag 6 will be assigned.

In case of a blood transfusion process, the patient to be correlated is instead a candidate for transfusion, to whom an identification bracelet 3a is given; said bracelet is of the disposable pediatric type and is provided with a correlation transponder 1, in which the predefined unique identification code is pre-entered.

In this manner, the recipient of the transfusion can be identified with absolute assurance even if his personal identification data are not known.

At any time during the process, by using a processor-equipped device 9 it is possible to load on the identification transponder the additional data related to the patient to be correlated, such as for example his surname, name, date of birth, sex, hospital identification code, and so forth.

If the processor-equipped device 9 is provided with said interfacing means 22 and the health facility has a local network (LAN) for data exchange, advantageously the additional data related to the patient to be correlated can be input into the identification transponder 1 also by means of a computer 23 located within the ward.

By means of the processor-equipped device 9, when blood is collected for pre-transfusion compatibility tests, the identifying information of the patient to be correlated is transferred from the identification transponder 1 to a correlation transponder 2, which is connected to a test tube 7 that is designed to contain the blood sample.

Since this transfer occurs at collection time, one avoids the risk of making mistakes in identifying the sample, even if there are no written indications on the test tube 7.

The blood sample, together with the associated request for testing, is sent to the transfusion center.

The test tube 7 is inserted here in the appropriately provided seat 21 of the printing means 19 in order to generate one or more identification labels, which are used to mark the test tube 7, any further test tubes derived from the first one, and a request form 5 for the analyses to be performed.

After performing the usual pretransfusion compatibility tests with the blood in the test tube 7, bags 6 that contain compatible donated blood are selected, and a respective correlation transponder 2 is applied to each one of said bags.

By using a processor-equipped device 9, the information is remotely transferred from the correlation transponder 1 of the test tube 7 to the respective second correlation transponders 2 of the compatible blood bags 6.

This produces a link of information between one or more correlated hospital products, i.e., the compatible blood bag or bags 6, and the patient to be correlated for whom they are intended (to protect privacy and data reliability, this information can be encrypted by means of said encryption/decryption means 24).

Each bag 6 intended for transfusion is assigned to the corresponding recipient by placing the bag in a plastic pouch together with the provided accompanying form.

This pouch is appropriately sealed so that it cannot be used unless one first verifies the match between the data stored in the memory unit of the identification transponder 1 assigned to the patient to be correlated and the data in the memory unit of the correlation transponder 2 rigidly coupled to the bag 6 that contains the compatible blood to be transfused.

At transfusion time, the assigned nursing staff, by using a processor-equipped device 9 optionally enabled for use by entering an operator identification code, reads the data of the identification transponder 1 and compares them with the data contained in the correlation transponder 2 of the bag 6.

If the data match, the signaling means 18 of the processor-equipped device 9 emit an acoustic and/or visual signal and the processor-equipped device 9 records in memory the data item indicating successful recognition.

At this point, the envelope can be opened and the blood contained in the bag can be transfused.

The nursing staff assigned to transfusions, by using the data entry means 14, enters in the memory 11 of the processor-equipped device 9 information related to the performed transfusion, such as the transfusion start and end times, parameters for the monitoring of the patient to be correlated, and any unwanted effects caused by the transfusion.

By way of the interfacing means 22, the information related to the performed transfusion can be downloaded into the computers 23 of the ward, by way of which it is possible to produce documents to be placed in the medical record of the patient to be correlated and/or to be sent to the transfusion center, such as for example the transfusion report.

The process for administering drugs, for example antiblastic drugs (or also other drugs), performed by using the positive identification device according to the invention entails assigning to a patient to be correlated, who is to receive the drug to be administered, an identification bracelet 3a equipped with an identification transponder 1 or, if the patient is being treated in a surgery/day hospital, a card 4, again provided with an identification transponder 1.

The nursing staff loads the full identification data of the patient to be correlated in the identification transponder 1, using a processor-equipped device 9.

Again by using the processor-equipped device 9, the information loaded in the memory unit of the identification transponder 1 is remotely transferred to the memory unit of a correlation transponder 2 that is attached to a request form 5, which is normally generated in order to request preparation of the drug.

When the request form 5 reaches the dispensary, a processor-equipped device 9 is used to read the content of the memory unit of the correlation transponder 2, and a safety label (checkpoint) is generated by virtue of printing means 19 connected thereto.

Once the drug has been prepared, it is stored in a container provided with another correlation transponder 2, to which a processor-equipped device 9 remotely transmits the information stored in the correlation transponder 1 located on the request form 5.

This produces a link of information between the correlated hospital product, which in this case is a drug, and the patient to be correlated, for whom said drug is intended (to protect privacy and data reliability, this information can be encrypted by way of the encryption/decryption means).

Once the operations for remote transfer of the information in the correlation transponder 2 associated with the drug have been performed, said drug is introduced in a clear plastic bag, which is sealed with a strap.

When the drug is to be administered, the match of the identification is checked by means of the processor-equipped device 9.

If the signaling means 18 emit an acoustic or visual signal confirming the match between the drug and the patient to be correlated, the bag is opened and the drug is infused.

The nursing staff then records in the memory 11 of a processor-equipped device 9 the start and end times of the infusion and any unwanted effects.

It is optionally possible to download this information from the processor-equipped device 9 to a ward computer 23 in order to allow full event logging.

As regards the possibility to use the positive identification device according to the invention during the steps for performing laboratory tests, for example on blood samples or histological specimens, a patient to be correlated who is being tested is given a card 4 or an identification bracelet 3a provided with an identification transponder 1, and the data stored therein are remotely transferred, by means of a processor-equipped device 9, into a correlation transponder 2 provided on a test tube 7, in the case of blood tests, or on a container for histological specimens in the case of histological tests.

Once the tests have been performed, a report is usually generated and is assigned to the corresponding patient to be correlated by reading his identification data stored in the correlation transponder 1 associated with the sample or specimen.

The report is then sent to the ward or given to the patient and included in the medical record.

By using a processor-equipped device 9, significant data of the exams performed, such as for example the blood group, can be remotely transferred to the identification transponder 1.

The positive identification device according to the invention can be advantageously used also in obstetrics; in this case, it is particularly useful to allow correct assignment of newborns to their respective mothers.

It is in fact possible for example to assign an identification bracelet 3a provided with an identification transponder 1 to the mother (who is the patient to be correlated) and at the same time assign to her newborn or newborns (who instead constitute the correlated patient or patients) a respective correlation bracelet 3a of the pediatric type provided with a correlation transponder 2.

The invention finally allows to solve the strongly felt problem of control of surgical instruments or dressings in the operating room.

In this case, a hospital product to be correlated, constituted by a surgical instrument, such as for example a scalpel 25 (but also a forceps, a pair of scissors or Klemmer forceps) or by gauzes, swabs or the like, is provided with an identification transponder 1 and a correlated product, constituted by the container of the product to be correlated, such as for example the box 8 of FIG. 4, is assigned a correlation transponder 2 in which the data contained in the identification transponder 1 are remotely transferred by means of a processor-equipped device 9.

In this manner it is possible to easily check that the surgical instruments and waste materials, such as gauzes or swabs, are all in their respective containers and are not inside the patient undergoing the operation.

In practice it has been found that the invention has achieved the intended aim and objects in all its embodiments.

The invention thus conceived is susceptible of numerous modifications and variations, all of which are within the scope of the appended claims.

In practice, the materials used, as well as the contingent shapes and dimensions, may be any according to requirements.

All the details may further be replaced with other technically equivalent elements.

The disclosures in Italian Patent Application No. VR2002A000112 from which this application claims priority are incorporated herein by reference.

What is claimed is:

1-25. (canceled)

26. A positive identification device particularly for establishing correctly a correlation between a hospital product or patient to be correlated and at least one hospital product or patient that is correlated to said hospital product or patient to be correlated, comprises:
first memory means, which can be affixed to said hospital product or patient to be correlated and store a predefined unique identification code for said hospital product or patient to be correlated;
second memory means, which can be affixed respectively to said at least one hospital product or patient that is correlated to said hospital product or patient to be correlated;
means for remote transfer of data, adapted to download by remote transmission the content of said first memory means into said second memory means.

27. The device according to claim 26, comprising comparator means that are adapted to compare the content of said first memory means with the content of said second memory means in order to verify correlation thereof.

28. The device according to claim 26, wherein said means for remote data transfer are adapted to download, by remote transmission, the content of said second memory means into said first memory means.

29. The device according to claim 26, wherein said first memory means are adapted to store additional data related to said hospital product or patient to be correlated.

30. The device according to claim 26, wherein said first memory means are adapted to store data related to said at least one correlated hospital product or patient.

31. The device according to claim 26, wherein said remote data transfer means operate via radiofrequency.

32. The device according to claim 26, further comprising an identification transponder for identifying the hospital product or patient to be correlated, which comprises said first memory means and is associable with said first hospital product or patient to be correlated, and at least one correlation transponder, which comprises said second memory means and is respectively associable with said at least one correlated hospital product or patient, said remote data transfer means comprising radiofrequency transponder reading means and radiofrequency transponder programming means.

33. The device according to claim 32, further comprising at least one processor-equipped device, said at least one processor-equipped device comprising said radiofrequency transponder reading means and said radiofrequency transponder programming means.

34. The device according to claim 33, wherein at least one processor-equipped device comprises said means and signaling means, which are functionally connected to said comparator means and are adapted to report the match between the content of said first memory means and the content of said second memory means.

35. The device according to claim 33, wherein said at least one processor-equipped device comprises data entry means.

36. The device according to claim 35, wherein said data entry means comprise a keyboard.

37. The device according to claim 33, wherein said at least one processor-equipped device comprises printing means.

38. The device according to claim 33, wherein said at least one processor-equipped device comprises display means that are adapted to display the content of said first memory means and of said second memory means.

39. The device according to claim 33, wherein said processor-equipped device comprises means for interfacing with at least one computer.

40. The device according to claim 33, wherein said processor-equipped device comprises encryption/decryption means that are adapted to encrypt/decrypt the content of said first memory means and of said second memory means.

41. The device according to claim 32, wherein said identification transponder is supported by an identification bracelet or by a card.

42. The device according to claim 32, wherein said at least one correlation transponder is provided with means for affixing to a container of said at least one correlated hospital product.

43. The device according to claim 42, wherein said affixing means comprise an adhesive label.

44. The device according to claim 32, wherein said at least one correlation transponder is integrated in said container.

45. The device according to claim 32, wherein said identification transponder and said at least one correlation transponder are disposable.

46. A method for correctly establishing a match between a hospital product or patient to be correlated and at least one hospital product or patient that is correlated to said first hospital product or patient to be correlated, comprising the steps of:
assigning to said hospital product or patient to be correlated first memory means that store a predefined unique code for identification of said first hospital product or patient to be correlated,
remotely transmitting and loading a content of said first memory means into second memory means associated respectively with said at least one correlated hospital product or patient,
performing a procedure for comparing the content of said first memory means and a content of said second memory means.

47. Method according to claim 46, wherein, between said assignment step and said remote transmission step, a step of remote loading additional data related to said hospital product or patient to be correlated in said first memory means.

48. The method according to claim 47, wherein said remote transmission step and said remote loading step are performed via radiofrequency.

49. The method according to claim 46, comprising a step of encrypting the data contained in said first memory means and in said second memory means and a step of decrypting the data encrypted in said encryption step.

50. The method according to claim 46, comprising a step of downloading the content of said first memory means or of said second memory means into at least one computer, which is connected over a network to a database of hospitalized patients.
